(19) United States
(12) Patent Application Publication
(10) Pub. No.: US 2020/0311624 A1
(43) Pub. Date: Oct. 1, 2020

(54) MANAGEMENT DEVICE, MANAGEMENT SYSTEM, MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Ryoma Taguchi, Tokyo (JP); Yuta Takada, Tokyo (JP)

(21) Appl. No.: 16/824,870

(22) Filed: Mar. 20, 2020

(30) Foreign Application Priority Data
Mar. 29, 2019 (JP) 2019-068975

(51) Int. Cl. G06Q 10/02; G08G 1/14; G06Q 30/02

(52) U.S. Cl. CPC G06Q 10/02; G06Q 30/0284; G08G 1/143

(57) ABSTRACT

A management device includes a first receiver configured to receive a first reservation for a use of a parking space of a parking lot for parking a vehicle, a second receiver configured to receive a second reservation for a use of a designated area different from the parking space of the parking lot for the first reservation, and an information processor configured to perform processing in accordance with a result of reception by the first receiver and a result of reception by the second receiver.

### CROSS-REFERENCE TO RELATED APPLICATION

Priority is claimed on Japanese Patent Application No. 2019-068975, filed Mar. 29, 2019, the content of which is incorporated herein by reference.

### BACKGROUND

### Field

The present invention relates to a management device, a management system, a management method, and a storage medium.

### Description of Related Art

Conventionally, a parking lot reservation management device which determines whether there is an overlap between a reserved entrance time and a reserved use time of a reserved vehicle and a scheduled entrance time and a scheduled use time according to a reservation request, and determines whether the reservation request can be received has been disclosed (Japanese Unexamined Patent Application, First Publication No. H9-16898).

However, in a conventional device, an operation of a user (for example, getting on/off, and the like) related to a parking lot reservation may not be considered. For this reason, management of vehicles may have not been efficient in some cases.

### SUMMARY

The present invention has been made in view of such circumstances, and an object thereof is to provide a management device, a management system, a management method, and a storage medium that can effectively manage vehicles.

The management device, the management system, the management method, and the storage medium according to the present invention have adopted the following configuration.

(1): A management device according to one aspect of the present invention is a management device including a first receiver configured to receive a first reservation for a use of a parking space of a parking lot for parking a vehicle, a second receiver configured to receive a second reservation for a use of a designated area different from the parking space of the parking lot for the first reservation, and an information processor configured to perform processing in accordance with a result of reception by the first receiver and a result of reception by the second receiver.

(2): In the aspect of (1) described above, the information processor is configured to execute processing for prompting a user of the vehicle to use a non-designated area different from the designated area when the first reservation is received and the second reservation is not received.

(3): In the aspect of (1) or (2) described above, when the first reservation and the second reservation are received, the information processor is configured to notify a terminal device of a user of the vehicle that the designated area can be used.

(4): In the aspect of any one of (1) to (3) described above, when the first reservation and the second reservation are received, the information processor is configured to notify a parking lot management device that is configured to manage the use of the designated area in a facility including the parking lot of information indicating the vehicle can use the designated area such that the user of the vehicle can use the designated area.

(5): In the aspect of (4) described above, when the first reservation is received and the second reservation is not received, the information processor is configured to notify the terminal device of the user of the vehicle of a use of a non-designated area different from the designated area.

(6): In the aspect of any one of (1) to (5) described above, the designated area is an area at which the user of the vehicle boards the vehicle, an area at which the user gets off the vehicle, an area at which the user loads luggage into the vehicle, or an area at which the user takes out the luggage from the vehicle.

(7): In the aspect of any one of (1) to (6) described above, the first reservation includes a parking start time, the second reservation includes a use end time, and the information processor is configured to receive the first reservation and the second reservation when the parking start time and the use end time are included in a first predetermined time range, and does not receive the first reservation or the second reservation when the parking start time and the use end time are not included in the first predetermined time range.

(8): In the aspect of any one of (1) to (7) described above, the first reservation includes a parking end time, the second reservation includes a use start time, and the information processor is configured to receive the first reservation and the second reservation when the parking end time and the use start time are included in a second predetermined time range, and does not is configured to receive the first reservation or the second reservation when the parking end time and the use start time are not included in the second predetermined time range.

(9): In the aspect of any one of (1) to (8) described above, the second reservation includes a use time for using the designated area, and the information processor is configured to receive the second reservation including a use time designated in unit time.

(10): In the aspect of any one of (1) to (9) described above, the information processor is configured to prioritize the second reservation of a user of a first type over the second reservation of a user of a second type.

(11): In the aspect of any one of (1) to (10) described above, a plurality of the designated areas are present, and the information processor is configured to allocate the use of the designated area associated with a first type among the plurality of the designated areas for the second reservation of a user of a first type, and is configured to allocate the use of the designated area associated with a second type among the plurality of the designated areas for the second reservation of a user of a second type.

(12): In the aspect of (10) or (11) described above, the user of the first type is a user who has a right to use the parking lot a plurality of times, and the user of the second type is a user who has a right to use the parking lot less frequently than the user of the first type.

(13): A management system according to another aspect of the present invention is a management system including the management device according to the aspect of any one of (1) to (12) described above, and a guidance device configured to cause a vehicle parking in the parking lot to exit from the parking lot and guide the vehicle to the designated area when the second reservation is received.

(14): In the management system of the aspect of (13) described above, the guidance device is configured to cause a vehicle parking in the parking lot to exit from the parking lot and is configured to guide the vehicle to a non-designated area different from the designated area when the second reservation is not received.

(15): A management system according to still another aspect of the present invention is a management system including the management device according to the aspect of any one of (1) to (12) described above, and a guidance device configured to guide a vehicle that has entered a facility having the parking lot to the designated area when the second reservation is received.

(16): In the management system of the aspect of (15) described above, the guidance device is configured to guide the vehicle that has entered the facility having the parking lot to a non-designated area different from the designated area when the second reservation is not received.

(17): A management system according to still another aspect of the present invention is a management system including the management device according to the aspect of any one of (1) to (12) described above, and a gate device configured to permit or not to permit an entrance into the designated area, in which the gate device permits an entry of a user or a vehicle correlated with the second reservation, and does not permit an entry of a user or a vehicle which is not correlated with the second reservation.

(18): A management device according to still another aspect of the present invention is a management device including a first acquirer configured to acquire a first reservation for a use of a parking space of a parking lot for parking a vehicle, a second acquirer configured to acquire a second reservation for a use of a designated area different from the parking space of the parking lot for the first reservation, and a guidance controller configured to guide a vehicle to a non-designated area different from the designated area when the first acquirer has not acquired a first reservation and the second acquirer has acquired a second reservation.

(19): In the aspect of (18) described above, the guidance controller is configured to guide the vehicle to the designated area when the first acquirer has acquired a first reservation and the second acquirer has acquired a second reservation.

(20): A management method according to still another aspect of the present invention is a management method including, by a computer, receiving a first reservation for a use of a parking space of a parking lot for parking a vehicle, receiving a second reservation for a use of a designated area different from the parking space of the parking lot for the first reservation, and performing processing in accordance with a reception result of the first reservation and a reception result of the second reservation.

(21): A non-transitory computer-readable storage medium that stores a computer program to be executed by a computer to perform at least: receiving a first reservation for a use of a parking space of a parking lot for parking a vehicle, receiving a second reservation for a use of a designated area different from the parking space of the parking lot for the first reservation, and performing processing in accordance with a reception result of the first reservation and a reception result of the second reservation.

According to (1) to (6), (20), and (21), processing in accordance with the reception result of a first reservation and a second reservation is performed, and thereby it is possible to efficiently manage a vehicle.

According to (7) and (8), since a management device receives a first reservation or a second reservation when time of the first reservation and time of the second reservation has satisfied a predetermined time condition, it is possible to manage a vehicle such that the vehicle can move more efficiently.

According to (9), since a management device receives a reservation in a desired unit time, it is possible to provide a service according to demand. As a result, convenience for a user is improved and a profit of an operator is improved.

According to (10) to (12), a management device performs processing in accordance with a type of a user, thereby improving the satisfaction level of a user. According to (13) to (17), since a guidance device is configured to guide a vehicle to a predetermined area according to a presence or absence of a second reservation, it is possible to guide the vehicle to a desired area more reliably.

According to (18) and (19), when a first reservation is acquired and a second reservation is not acquired, a management device is configured to guide a vehicle to a non-designated area different from a designated area, thereby managing a vehicle more efficiently.

### BRIEF DESCRIPTION OF THE DRAWINGS

FIG. 1 is a configuration diagram of a parking lot management system including a vehicle system.

FIG. 2 is a diagram which shows an example of a functional configuration of the vehicle system.

FIG. 3 is a functional configuration diagram of a first controller and a second controller.

FIG. 4 is a diagram which schematically shows a scene in which an autonomous parking event is executed.

FIG. 5 is a diagram which shows an example of a configuration of a parking lot management device.

FIG. 6 is a diagram which shows an example of a functional configuration of a reservation management device.

FIG. 7 is a flowchart which shows an example of a flow of processing executed by the reservation management device and a terminal device.

FIG. 8 is a diagram showing processing for identifying recommended information.

FIG. 9 is a diagram which shows an example of content of information displayed on a display.

FIG. 10 is a diagram which shows another example of the content of the information displayed on the display.

FIG. 11 is a flowchart which shows an example of a flow of entrance processing executed by a parking lot management system.

FIG. 12 is a diagram which shows an example of a state in which a vehicle is guided to a first stop area.

FIG. 13 is a flowchart which shows an example of a flow of exit processing executed by the parking lot management system.

FIG. 14 is a diagram which shows an example of a state in which a vehicle is guided to a third stop area.

FIG. 15 is a diagram which shows an example of a functional configuration of a parking lot management device according to a second embodiment.

FIG. 16 is a diagram which shows an example of a scene in which a user who has not made a second reservation uses the first stop area.

FIG. 17 is a diagram which shows an example of a hardware configuration of an automated driving control device of the embodiment.

### DETAILED DESCRIPTION

Hereinafter, a management device, a management system, a management method, and a storage medium of the present invention will be described with reference to the drawings.

### First Embodiment

[Overall Configuration]

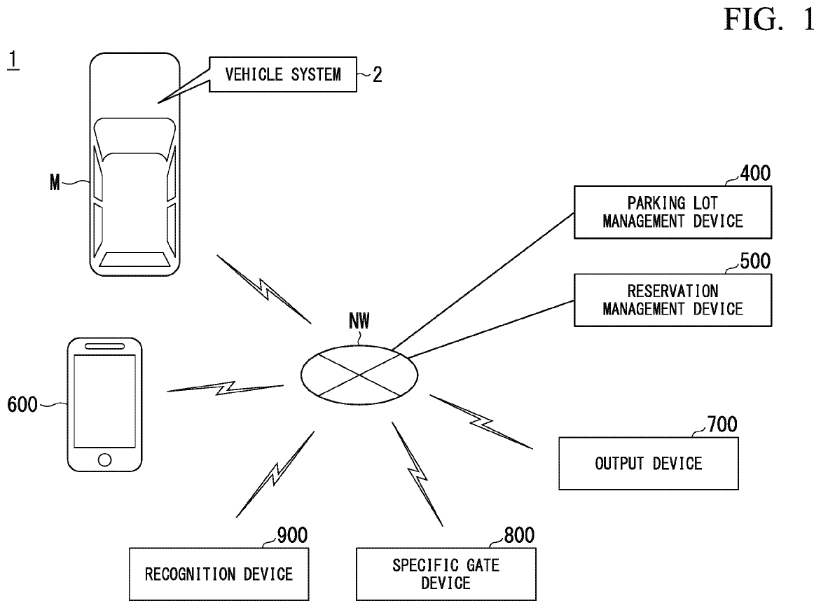

FIG. 1 is a configuration diagram of a parking lot management system 1 including a vehicle system 2. The parking lot management system 1 includes, for example, one or more vehicles (hereinafter, a vehicle M) equipped with the vehicle system 2, one or more parking lot management devices 400, one or more reservation management devices 500, one or more terminal devices 600, one or more output devices 700, one or more specific gate devices 800, and a recognition device 900. These components can communicate with each other via a network NW. The network NW includes a cellular network, a Wi-Fi network, the Internet, a wide area network (WAN), a local area network (LAN), a public line, a provider device, a dedicated line, a wireless base station, and the like. Each of these components may directly perform wireless communication without going through the network NW. First, details of the terminal device 600 and the vehicle system 2 will be described below.

The terminal device 600 is, for example, a terminal device that can be carried by a user, such as a smartphone, a tablet terminal, and a personal computer. The terminal device 600 communicates with the vehicle M, and transmits a request of the user to the vehicle M or performs push notification based on information received from the vehicle M or the parking lot management device 400. The terminal device 600 communicates with the reservation management device 500 and makes a reservation for parking the vehicle M in a predetermined parking lot.

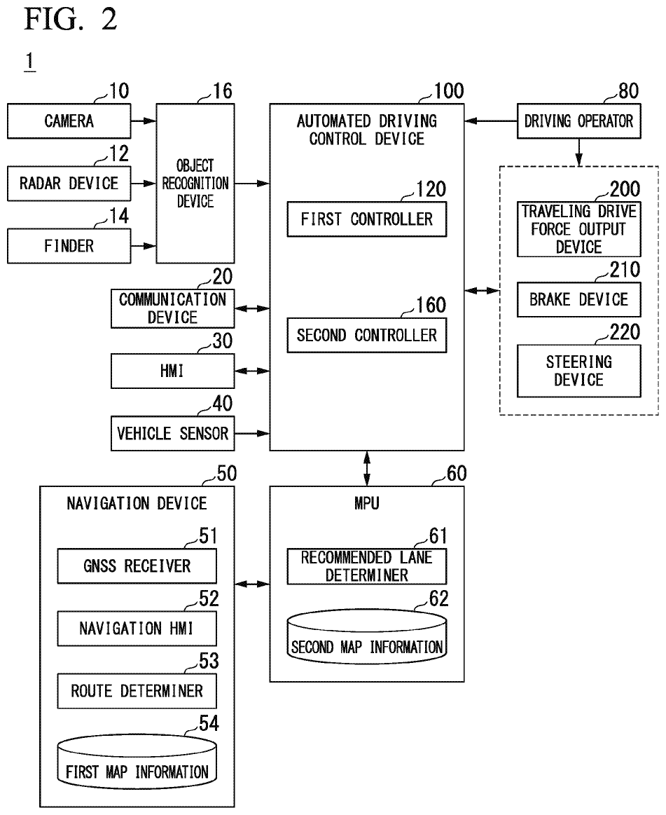

FIG. 2 is a diagram which shows an example of a functional configuration of the vehicle system 2. A vehicle on which the vehicle system 2 is mounted is, for example, two-wheel, three-wheel, or four-wheel vehicle, and a driving source thereof is an internal combustion engine such as a diesel engine or a gasoline engine, an electric motor, or a combination thereof. The electric motor operates using electric power generated by a generator connected to the internal combustion engine, or electric power discharged from a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. The configuration shown in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of a vehicle on which the vehicle system 2 is mounted. The vehicle system 2 includes, for example, a plurality of cameras 10. The camera 10 is attached to, for example, an upper part of the front windshield, a rear surface of the rear view mirror, or the like, and captures an image of the front of the vehicle. The camera 10 is attached to, for example, an upper part of a rear windshield, near a license plate on a rear outside of the vehicle, or near a trunk door on the rear outside of the vehicle, and captures an image of the rear of the vehicle. The camera 10 periodically and repeatedly captures images of a vicinity of the vehicle M. The camera 10 may also be a stereo camera.

The radar device 12 radiates radio waves such as millimeter waves to the vicinity of the vehicle M, and detects at least a position (a distance and an orientation) of an object by detecting radio waves (reflected waves) reflected by the object. The radar device 12 is attached to an arbitrary position of the vehicle M. The radar device 12 may detect the position and a speed of the object using a frequency modulated continuous wave (FM-CW) method.

The finder 14 is a light detection and range (LIDAR). The finder 14 radiates light to the vicinity of the vehicle M and measures scattered light. The finder 14 detects a distance to the target on the basis of time from light emission and light reception. The radiated light is, for example, pulsed laser light. The finder 14 is attached to an arbitrary position of the vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may be omitted from the vehicle system 2.

The communication device 20 uses, for example, a cellular network, a Wi-Fi network, a Bluetooth (a registered trademark), a dedicated short range communication (DSRC), or the like, and communicates with another vehicle or a parking lot management device (to be described below) present in the vicinity of the vehicle M or various types of server devices.

The HMI 30 presents various types of information to a user of the vehicle M and receives an input operation from the user. The HMI 30 includes various display devices, speakers, buzzers, touch panels, switches, keys, and the like.

The vehicle sensor 40 includes a vehicle speed sensor that detects the speed of the vehicle M, an acceleration sensor that detects the acceleration, a yaw rate sensor that detects an angular speed around a vertical axis, an orientation sensor that detects a direction of the vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the vehicle M identified by the GNSS receiver 51 to a destination input from the user using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal owned by the user. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane to travel from the left. When there is a branch point in the route on a map, the recommended lane determiner 61 determines a recommended lane such that the vehicle M travels in a reasonable route for traveling to a branch destination.

The second map information 62 is map information with higher accuracy than the first map information 54. The second map information 62 includes, for example, information on a center of a lane or information on a boundary of the lane. The second map information 62 may include road information, traffic regulation information, address information (addresses/postal codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving control device 100 or some or all of the traveling drive force output device 200, the brake device 210, and the steering device 220.

The automated driving control device 100 includes, for example, a first controller 120 and a second controller 160. Each of the first controller 120 and the second controller 160 is realized, for example, by a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), and a graphics processing unit (GPU), and may also be realized by a cooperation of software and hardware. The program may be stored in advance in a storage device (a storage device including a non-transitory storage medium) such as an HDD or a flash memory of the automated driving control device 100, or may be stored in a detachable storage medium such as a DVD or a CD-ROM and installed in the HDD or the flash memory of the automated driving control device 100 by the storage medium (the non-transitory storage medium) being mounted on a drive device.

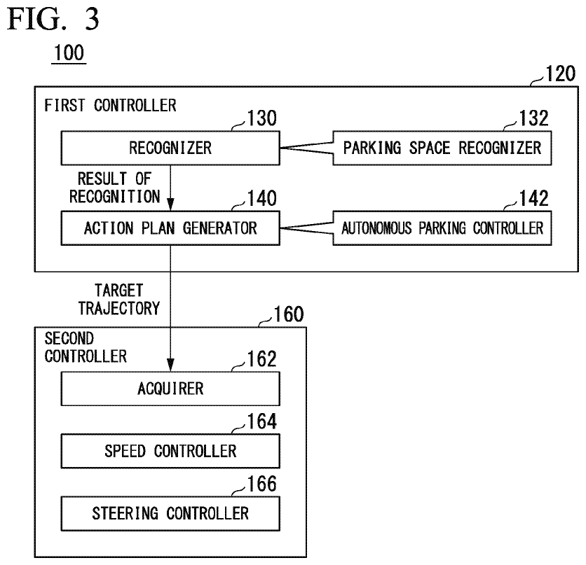

FIG. 3 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be realized by executing a recognition of an intersection by deep learning or the like and a recognition based on conditions (including pattern matching signals, road markings, and the like) given in advance in parallel and comprehensively evaluating the both by scoring them. As a result, a reliability of automated driving is guaranteed.

The recognizer 130 recognizes state such as the position, speed and acceleration of the object in the vicinity of the vehicle M on the basis of information input from the camera 10, the radar device 12, and the finder 14 via the object recognition device 16. The position of the object is, for example, recognized as a position on absolute coordinates having the origin at a representative point (a center of gravity, a center of a drive axis, or the like) of the vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane is changed or is intended to be changed).

The recognizer 130 recognizes, for example, a lane (traveling lane) in which the vehicle M is traveling. For example, the recognizer 130 recognizes a traveling lane by comparing a pattern (for example, an array of solid lines and dashed lines) of a road section line obtained from the second map information 62 with a pattern of a road section line in the vicinity of the vehicle M recognized from an image captured by the camera 10. The recognizer 130 may recognize a traveling lane by recognizing not only a road section line but also a traveling road boundary (road boundary) including road section lines, road shoulders, curbs, median strips, guardrails, and the like. In this recognition, the position of the vehicle M acquired from the navigation device 50 and a result of processing performed by the INS may be added. The recognizer 130 recognizes temporary stop lines, obstacles, red light, tollgates, or other road events.

When a traveling lane is recognized, the recognizer 130 recognizes the position and posture of the vehicle M with respect to the traveling lane. The recognizer 130 may recognize, for example, a deviation of a reference point of the vehicle M from a lane center and an angle formed with respect to a line connecting the lane centers in a traveling direction of the vehicle M as the relative position and posture of the vehicle M with respect to the traveling lane. Instead, the recognizer 130 may recognize a position and the like of the reference point of the vehicle M with respect to either side end (a road section line or a road boundary) of the traveling lane as the relative position of the vehicle M with respect to the traveling lane.

The recognizer 130 includes a parking space recognizer 132 that is started in an autonomous parking event to be described below. Details of functions of the parking space recognizer 132 will be described below.

In principle, the action plan generator 140 travels on a recommended lane determined by the recommended lane determiner 61, and furthermore, generates a target trajectory in which the vehicle M will automatically (without depending on an operation of the driver) travel to be able to cope with the vicinity situation of the vehicle M. The target trajectory includes, for example, a speed element. For example, the target trajectory is expressed as a sequence of points (orbit points) to be reached by the vehicle M. The orbit points are points to be reached by the vehicle M for each predetermined traveling distance (for example, about several [m]) in a road distance, and separately from this, a target speed and a target acceleration for each predetermined sampling time (for example, about 0 commas[sec]) are generated as a part of the target trajectory. The orbit points may be positions to be reached by the vehicle M at a corresponding sampling time for each predetermined sampling time. In this case, the information on the target speed and the target acceleration is expressed by an interval between the orbit points.

The action plan generator 140 may set an automated driving event in generation of a target trajectory. Examples of the automated driving event include a constant-speed traveling event, a low-speed following traveling event, a lane change event, a branching event, a merging event, a takeover event, an autonomous parking event in which unmanned traveling or automated traveling is performed to park in valet parking and the like, and the like. The action plan generator 140 generates a target trajectory in accordance with a started event. The action plan generator 140 includes an autonomous parking controller 142 which is started when an autonomous parking event is executed. Details of functions of the autonomous parking controller 142 will be described below. The second controller 160 controls the traveling drive force output device 200, the brake device 210, and the steering device 220 such that the vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (orbit points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the vehicle M and the feedback control based on a deviation from the target trajectory.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque associated with a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second controller 160 or the information input from the driving operator 80.

[Autonomous Parking Event—At the Time of Entrance]

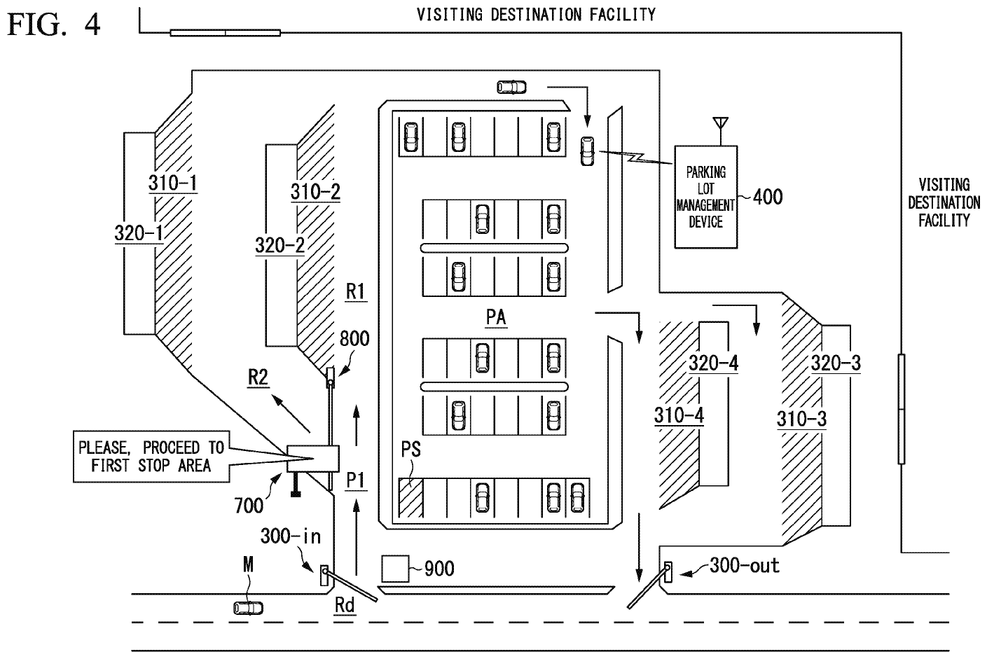

The autonomous parking controller 142 causes the vehicle M to park in a parking space on the basis of information acquired from the parking lot management device 400 by the communication device 20. FIG. 4 is a diagram which schematically shows a scene in which an autonomous parking event is executed. The parking lot management device 400 includes a controller 420 and a storage 430. The controller 420 includes a first acquirer 422 and a second acquirer 424.

The first acquirer 422 acquires a first reservation for a use of a parking space of a parking lot for parking a vehicle. The second acquirer 424 acquires a second reservation for a use of a designated area different from the parking space of the parking lot for the first reservation. The controller 420 guides a vehicle to a non-designated area different from the designated area when the first acquirer 422 has acquired the first reservation and the second acquirer 424 has not acquired the second reservation. The controller 420 guides a vehicle to a designated area when the first acquirer 422 has acquired the first reservation and the second acquirer 424 has acquired the second reservation.

Gates 300-in and 300-out are provided in a route from a road Rd to a visiting destination facility. The vehicle M proceeds to a first stop area 310-1 or a second stop area 310-2 through the gate 300-in by manual driving or automated driving. For example, if the vehicle M proceeds in a straight line to a main line R1 after passing through the gate 300-in, the vehicle M reaches the second stop area 310-2, enters a branch road R2 without proceeding in a straight line after passing through the gate 300-in, and the vehicle M reaches the first stop area 310-1 if it travels on the branch road R2. An output device 700 and a specific gate device 800 are provided at a connection point P1 between the main line R1 and the branch road R2. The first stop area 310-1 faces a first getting-on/off area 320-1 from which the visiting destination facility can be accessed. The second stop area 310-2 faces a second getting-on/off area 320-2 from which the visiting destination facility can be accessed.

The output device 700 outputs information indicating that the vehicle proceeds to the first stop area 310-1 or outputs information indicating that the vehicle proceeds to the second stop area 310-2 to the vehicle M approaching the connection point P1.

The specific gate device 800 allows an entry into the first stop area 310-1 or blocks an entry into the second stop area 310-2.

The output device 700, the specific gate device 800, or the parking lot management device 400 are examples of a guidance device that causes the vehicle M having parked in the parking lot to exit from the parking lot and guides the vehicle M to a designated area when the second reservation is received. The specific gate device 800 is an example of a gate device and the output device 700 is an example of a providing device.

The recognition device 900 is provided near a place in which the gate 300-in is provided. The recognition device 900 recognizes information for identifying the vehicle M that is about to enter the facility through the gate 300-in. For example, the recognition device 900 includes a camera that captures an image of a license plate of the vehicle M, and a recognition processer that recognizes numbers and characters on the license plate on the basis of the image captured by the camera.

The recognition device 900 may be a device which includes an IC card reader or the like. In this case, the recognition device communicates with the IC card held by the user of the vehicle M, acquires information transmitted by the IC card, and recognizes a user ID and a vehicle ID on the basis of the acquired information. The recognition device 900 may directly communicate with the vehicle M and acquire information for identifying the vehicle M. A part of processing performed by the recognition device 900 may also be performed by the reservation management device 500 or the parking lot management device 400.

The host vehicle M starts an autonomous parking event in which unmanned (or manned) automated driving is performed to move to a parking space PS in the parking lot PA after the user or luggage is unloaded at the first stop area 310-1 or the second stop area 310-2 (stop area 310). A start trigger of the autonomous parking event may be, for example, some operations performed by the user, or may be a reception of a predetermined signal wirelessly from the parking lot management device 400. The autonomous parking controller 142 controls the communication device 20 such that it transmits a parking request to the parking lot management device 400 when the autonomous parking event is started. Then, the vehicle M moves from the stop area 310 to the parking lot PA according to a guidance of the parking lot management device 400 or while performing sensing by itself.

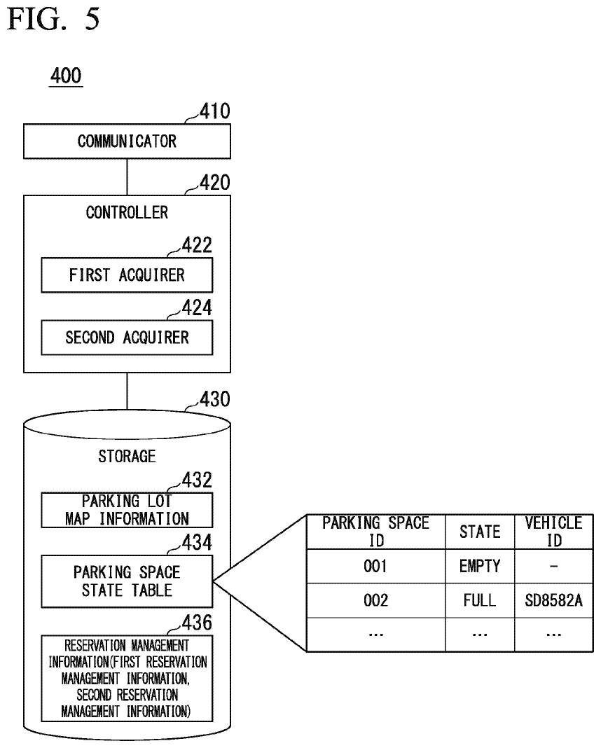

FIG. 5 is a diagram which shows an example of a configuration of the parking lot management device 400. The parking lot management device 400 includes, for example, a communicator 410, a controller 420, and a storage 430. The storage 430 stores information such as parking lot map information 432, a parking space state table 434, reservation management information 436, identification information of a user, identification information of a vehicle M, identification information of the terminal device 600 of a user, and information in which the identification information of a user, the identification information of a vehicle M, and the identification information of the terminal device 600 are associated with each other. The parking lot management device 400 is an example of a guidance device which causes a vehicle M parking in a parking lot to exit from the parking lot and guides the vehicle M to a designated area when the second reservation is received.

The communicator 410 wirelessly communicates with a vehicle M and other vehicles. The controller 420 guides the vehicle M to the parking space PS on the basis of information acquired by the communicator 410 and information stored in the storage 430. The parking lot map information 432 is information in which a structure of the parking lot PA is geometrically represented. The parking lot map information 432 includes coordinates for each parking space PS. The parking space state table 434 includes, for example, a state indicating that a parking space is in an empty state or in a full (parking) state, and a vehicle ID that is identification information of a parking vehicle M when a parking space is in the full state in association with a parking space ID that is identification information of the parking space PS.

If the communicator 410 receives the parking request from a vehicle M, the controller 420 extracts a parking space PS which is in the empty state with reference to the parking space state table 434, acquires a position of the extracted parking space PS from the parking lot map information 432, and transmits a preferred route to the position of the acquired parking space PS to the vehicle M using the communicator 410. The controller 420 instructs a specific vehicle M to stop or slow down when necessary on the basis of a positional relationship of a plurality of vehicles M such that vehicles M do not proceed to the same position at the same time.

In the vehicle M that has received the route, the autonomous parking controller 142 generates a target trajectory based on the route. If a target parking space PS is approached, the parking space recognizer 132 recognizes a parking frame line or the like that partitions the parking space PS, and recognizes a detailed position of the parking space PS to provide it to the autonomous parking controller 142. The autonomous parking controller 142 corrects the target trajectory after receiving this and causes the vehicle M to park in the parking space PS.

[Autonomous Parking Event—At the Time of Exit]

The autonomous parking controller 142 and the communication device 20 maintain an operating state even while the vehicle M parks. The autonomous parking controller 142 causes a system of the vehicle M to start and causes the vehicle M to move to the third stop area 310-3 or the fourth stop area 310-4, for example, when the communication device 20 receives a pick-up request from a terminal device 600 of the user. The third stop area 310-3 faces the third getting-on/off area 320-3 which is accessible from the visiting destination facility. The fourth stop area 310-4 faces the fourth getting-on/off area 320-4 which is accessible from the visiting destination facility. At this time, the autonomous parking controller 142 controls the communication device 20 such that it transmits a take-off request to the parking lot management device 400. The controller 420 of the parking lot management device 400 instructs a specific vehicle M to stop or slow down when necessary on the basis of the positional relationship of a plurality of vehicles M such that the vehicles M do not proceed to the same position at the same time just like at the time of entrance. If the vehicle M is moved to the third stop area 310-3 or the fourth stop area 310-4 to allow the user, luggage, or the like to be loaded, the autonomous parking controller 142 stops operating, and thereafter, manual driving or automated driving performed by another functional part is started. When there is no distinction between the first stop area 310-1 and the third stop area 310-3, these may be simply referred to as “designated areas.” When there is no distinction between the second stop area 310-2 and the fourth stop area 310-4, these may be simply referred to as “non-designated areas.” When the fourth getting-on/off area 320-4 is not distinguished from the first getting-on/off area 320-1, these may be simply referred to as “getting-on/off areas 320.”

The autonomous parking controller 142 is not limited to the description above, and may find a parking space in the empty state by itself on the basis of a result of detection performed by the camera 10, the radar device 12, the finder 14, or the object recognition device 16 independently of communication, and cause the vehicle M to park in the found parking space.

[Reservation Management Device]

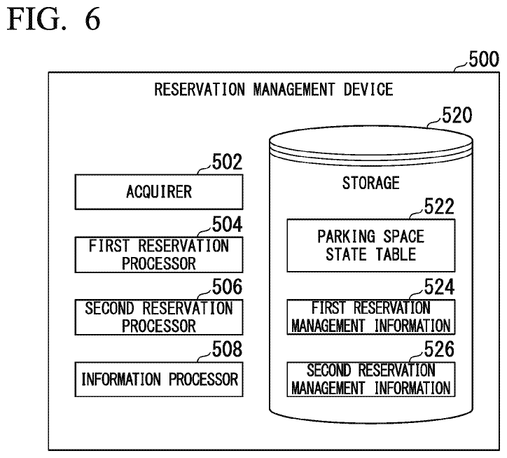

FIG. 6 is a diagram which shows an example of a functional configuration of a reservation management device 500. The reservation management device 500 includes, for example, an acquirer 502, a first reservation processor 504 (first receiver), a second reservation processor 506 (second receiver), an information processor 508, and a storage 520. The storage 520 includes, for example, a parking space state table 522, first reservation management information 524, second reservation management information 526, and the like. The parking space state table 522 is the same information as the parking space state table 434. The parking space state table 522 is information provided by the parking lot management device 400. Details of the first reservation management information 524 and the second reservation management information 526 will be described below.

The acquirer 502 acquires information transmitted by the terminal device 600 on the basis of an instruction of a user. This information is information on a reservation for use of a parking lot or a reservation for a use of the getting-on/off area 320 (stop area 310).

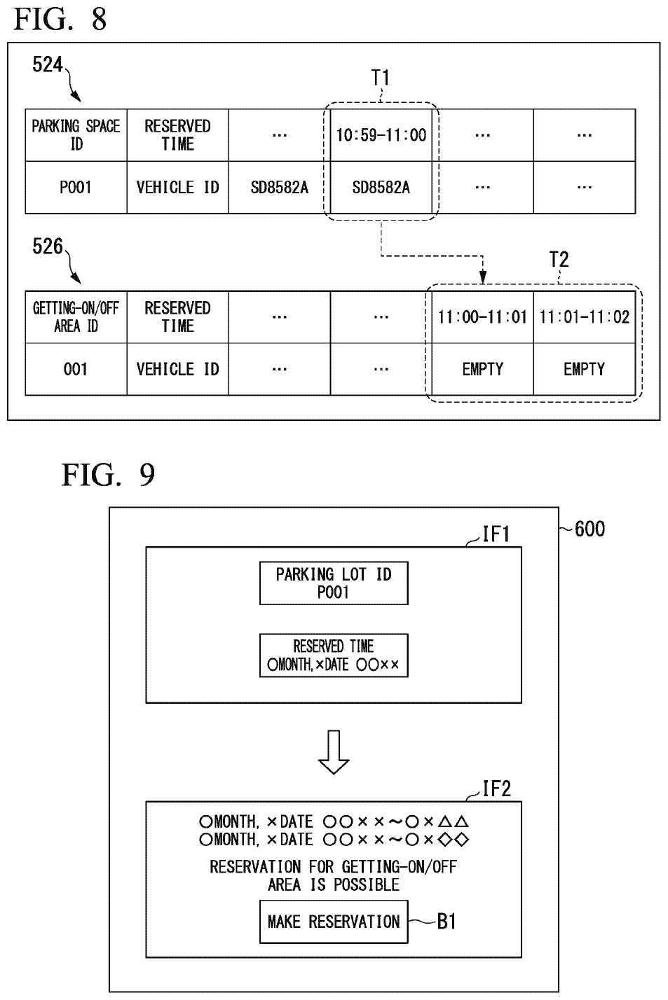

The first reservation processor 504 receives a first reservation for the use of a parking space of a parking lot for parking a vehicle M on the basis of information acquired by the acquirer 502. The first reservation is, for example, information including a vehicle space ID, a parking vehicle ID, and parking time. “Receiving” means, for example, acquiring the first reservation. “Receiving” may mean acquiring the first reservation and associating content of the acquired first information with the first reservation management information 524 (refer to FIG. 8) of the storage 520 or acquiring the first reservation and confirming the acquired first reservation.

The second reservation processor 506 receives a second reservation for the use of a designated area different from the parking space of the parking lot for the first reservation on the basis of information acquired by the acquirer 502. “Operation” means any operation performed on the vehicle M or an object included in the vehicle M such as an operation of a user getting on or off the vehicle M, an operation of a user taking out luggage from the vehicle M, or an operation of a user loading luggage into the vehicle M.

The designated area is an area on which the operations described above are performed (the first stop area 310-1, the third stop area 310-2). The designated area is an area in which a user who has made a second reservation gets on the vehicle M, an area in which the user gets off the vehicle M, an area in which the user loads luggage into the vehicle M, or an area in which the user takes out the luggage from the vehicle M.

The second reservation is, for example, information including a getting-on/off area ID, a using vehicle ID, and a using time. Receiving means, for example, acquiring the second reservation. Receiving may mean acquiring the second reservation and associating content of the acquired second reservation with the second reservation management information 526 (refer to FIG. 8) of the storage 520 or acquiring the second reservation and confirming the acquired second reservation.

The information processor 508 performs processing in accordance with a result of reception by the first reservation processor 504 and a result of reception by the second reservation processor 506. The information processor 508 guides the vehicle M or the user to a designated area or a non-designated area according to a result of reception. For example, the information processor 508 performs notification on the terminal device 600 or provides information of the first reservation or the second reservation to the parking lot management device 400 to perform the guidance. Details of this processing will be described below. The second stop area 310-2 or the fourth stop area 310-4 is an example of the “non-designated area.”

[Reservation Processing]

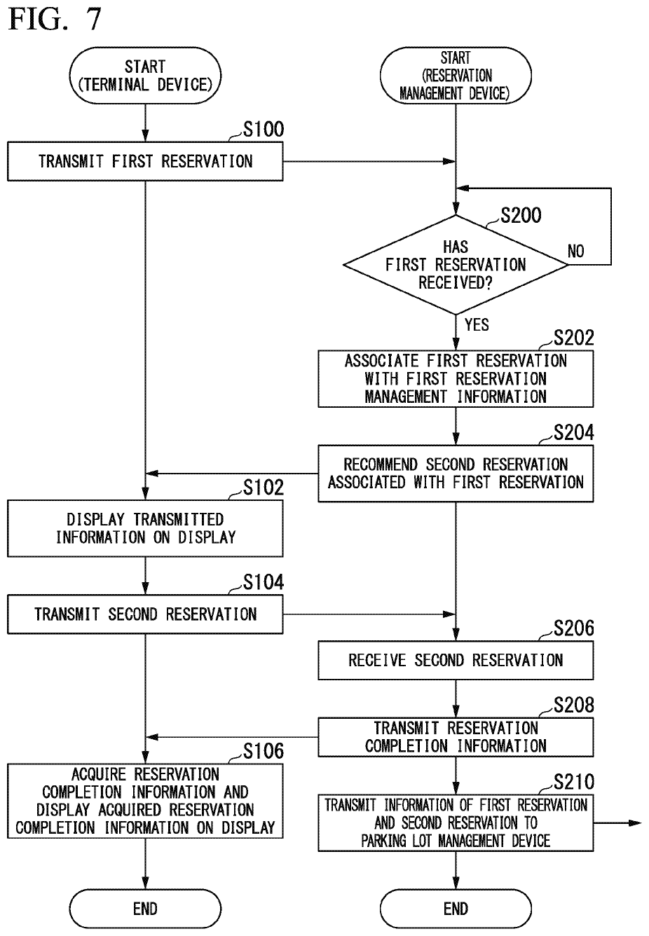

FIG. 7 is a flowchart which shows an example of a flow of processing executed by the reservation management device 500 and the terminal device 600. First, the terminal device 600 transmits the first reservation and identification information of a user to the reservation management device 500 (step S100). If the reservation management device 500 receives the identification information of a user and the first reservation transmitted by the terminal device 600, it associates the first reservation with the first reservation management information 524 (step S202). Associating is that information on the transmitted first reservation is stored in the first reservation management information 524 of the storage 520 as one record. As a result, the first reservation is confirmed.

Next, the reservation management device 500 recommends a second reservation associated with the first reservation (step S204). The information processor 508 of the reservation management device 500 provides information on the second reservation to the user when the first reservation is received. The information on the second reservation includes information indicating a time at which the first stop area 310-1 or the third stop area 310-3 can be used. For example, the reservation management device 500 identifies a time at which the second reservation to be recommended is possible and a boarding area (stop area) on the basis of the first reservation, and transmits the identified information and information on the first reservation to the terminal device 600.

FIG. 8 is a diagram showing processing of identifying information to be recommended. For example, the reservation management device 500 refers to the first reservation in the first reservation management information 524, derives a time based on a parking start time of the first reservation and a time based on a parking end time of the first reservation, and identifies the time at which the second reservation to be recommended is possible and the boarding area on the basis of the derived time.

The time based on a parking start time of the first reservation is time in which a user is assumed to use the getting-on/off area 320 before the vehicle M is caused to park in a parking lot at the parking start time. For example, the time based on a parking start time of the first reservation is time before the parking start time, and time from the parking start time to predetermined time before (for example, 5 minutes before or 10 minutes before) the parking start time. For example, when the parking start time of the first reservation is 10:00, the second reservation from 9:50 to 10:00 is recommended.

The time based on a parking end time (T1 in FIG. 8) of the first reservation is time (T2 in FIG. 8) in which a user is assumed to use the getting-on/off area 320 after the vehicle M is caused to exit from the parking lot at the parking end time. For example, the time based on a parking end time of the first reservation is time after the parking end time, and time from the parking end time to predetermined time after (for example, 5 minutes after or 10 minutes after) the parking end time. For example, when the parking end time of the first reservation is 11:00, the second reservation from 11:00 to 11:10 is recommended.

Returning to the description of FIG. 7, the terminal device 600, next, causes a display to display information transmitted by the reservation management device 500 (step S102). FIG. 9 is a diagram which shows an example of content of the information displayed on the display. For example, information IF1 indicating that the first reservation is completed and information on the second reservation of the getting-on/off area 320 associated with the first reservation are displayed on the display. A reservation button B1 for requesting a reservation of the getting-on/off area 320 is displayed on the display.

If the user operates the reservation button B1, the terminal device 600 transmits the information of the second reservation in accordance with an operation to the reservation management device 500 (step S104). Next, the reservation management device 500 acquires the information transmitted in step S104 and receives the second reservation associated with the first reservation on the basis of the acquired information (step S206). In this case, the reservation management device 500 associates the second reservation with the second reservation management information 526. Then, the reservation management device 500 manages the first reservation and the second reservation in association with each other. Managing in association means that the reservation management device 500 manages the second reservation of the user in association with the first reservation of the user, and manages the first reservation and the second reservation in such a manner that the second reservation can be identified by referring to the first reservation, or the first reservation can be identified by referring to the second reservation.

The reservation management device 500 may cause more allowance for the first reservation than for the second reservation. For example, the reservation management device 500 may increase an allowance level of a use limit for the use of the parking lot and an allowance level of a use frame for the use of the stop area. For example, when a use limit for the getting-on/off area is left at “10”, the reservation management device 500 leaves the use limit for the parking lot at a number exceeding “10.” As a result, even if there is a vehicle M having parked beyond reserved time, a vehicle M which has made the first reservation can smoothly park in the parking lot.

Next, the reservation management device 500 transmits reservation completion information indicating that the first reservation and the second reservation have been completed to the terminal device 600 (step S208). The information processor 508 of the reservation management device 500 notifies the terminal device 600 of a user that a designated area can be used when the first reservation and the second reservation are received as described above.

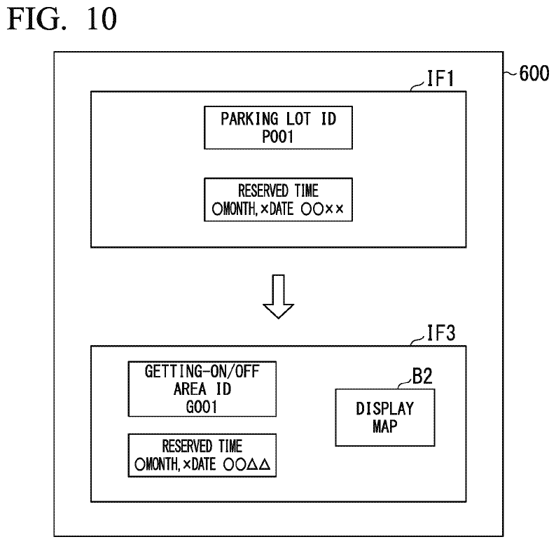

Next, the terminal device 600 acquires the completion information transmitted by the reservation management device 500, and causes the display to display the acquired reservation completion information (step S106). FIG. 10 is a diagram which shows another example of content of the information displayed on the display. For example, the display displays information IF1 indicating that the first reservation has been complete, information IF3 indicating that the second reservation associated with the first reservation has been completed. The information IF3 includes information indicating a reserved boarding area, information indicating a reserved time, and a button B2 for displaying a position of the getting-on/off area 320 on a map.

The reservation management device 500 executes processing for prompting the user to use a non-designated area when the first reservation is received but the second reservation is not received. Prompting processing means processing in which the reservation management device 500 notifies the terminal device 600 of the user of the use of a non-designated area, or providing information on a reservation (reservation management information) to the parking lot management device 400 such that the user is guided to a non-designated area by the specific gate device 800 or the output device 700.

After the processing of step S208, the reservation management device 500 transmits information of the first reservation and the second reservation or information of the first reservation to the parking lot management device 400 (step S210). When the first reservation and the second reservation are received, the information processor 508 of the reservation management device 500 notifies the parking lot management device 400 which manages the use of a designated area in the facility including the parking lot of information indicating that the vehicle M can use the designated area such that the user can use the first stop area 310-1. The parking lot management device 400 guides the vehicle M to the designated area such that the user can use the designated area as described below if the notification described above is received. As a result, processing of this flowchart ends.

As described above, since the user can further make a reservation for the getting-on/off area 320 in addition to a reservation for the parking lot, the convenience for the user is improved.

[Time of First Reservation and Second Reservation]

In the first reservation or the second reservation described above, a reservation is made in a designated unit time. The unit time may be a unit time in a minute or a unit time of predetermined time such as one hour, 30 minutes, 15 minutes, 5 minutes, or 1 minute.

The reservation management device 500 may change a length of a first unit time, a length of a second unit time, or the length of the first unit time and the length of the second unit time. The reservation management device 500 may change the length of the first unit time, the length of the second unit time, or the length of the first unit time and the length of the second unit time on the basis of a time period or a season. For example, the reservation management device 500 shortens the length of the first unit time or the second unit time described above during a peak season, or extends the length of the first unit time or the second unit time described above during an off-season. For example, shorter unit time may be set in the morning or evening, which is time of commuting or returning home, and longer unit time may be set in the daytime.

The first unit time may be, for example, longer time than the second unit time. For example, the reservation management device 500 may not receive the first reservation or the second reservation when the first unit time is shorter than the second unit time.

[Restriction on Reservation (Part 1)]

The first reservation includes first use time for using a parking lot designated in the first unit time, and the second reservation includes second use time for using the designated area designated in the second unit time different from the first unit time. That is, the reservation management device 500 manages the first reservation and the second reservation, in principle, such that the first use time reserved in the first reservation does not overlap the second use time reserved in the second reservation.

The first use time and the second use time may be set to partially overlap. For example, the is because the user may cause the vehicle M to exit, and cause the vehicle M to enter the parking lot again after loading luggage into the vehicle M in the getting-on/off area 320 during shopping.

[Restriction on Reservation (Part 2)] The reservation management device 500, regarding the reception of the second reservation, may receive the first reservation and the second reservation when the parking start time of the first reservation and the use end time of the second reservation are included in a range of first predetermined time, and may not receive the first reservation or the second reservation when the parking start time of the first reservation and the use end time of the second reservation are not included in the range of first predetermined time.

For example, when the first predetermined time is one minute, the reservation management device 500 receives this reservation when the parking start time of the first reservation is 10:00 and the use end time of the second reservation is “9:59,” and does not receive this reservation when the use end time of the second reservation is “9:58.” This is because, if there is a difference between these times, it is necessary for the vehicle M to wait on a way from the stop area to the parking lot, and the vehicle M cannot move smoothly.

[Restriction on Reservation (Part 3)]

The reservation management device 500, regarding the reception of the second reservation, may receive the first reservation and the second reservation when the parking end time of the first reservation and the use start time of the second reservation are included in a range of second predetermined time, and may not receive the first reservation or the second reservation when the parking end time of the first reservation and the use start time of the second reservation are not included in the range of second predetermined time.

For example, when the second predetermined time is one minute, the reservation management device 500 receives this reservation when the parking end time of the first reservation is 10:00 and the use start time of the second reservation is “10:01,” and does not receive this reservation when the use start time of the second reservation is “10:02.” This is because, if there is a difference between these times, it is necessary for the vehicle M to wait on a way from the parking lot to the stop area, and the vehicle M cannot move smoothly.

As described in [Time of first reservation and second reservation] and [Restriction on reservation (Part 1)] to [Restriction on reservation (Part 3)] described above, the reservation management device 500 realizes a more efficient operation by adjusting the unit time of the first reservation or the second reservation or providing a restriction on the reservation.

[Restriction on Reservation (Part 4)]

The reservation management device 500 may prioritize the second reservation of a user of a first type over the second reservation of a user of a second type. For example, the reservation management device 500 may receive the second reservation of a user of a first type and may not receive the second reservation of a user of a second type during predetermined time or predetermined season. The reservation management device 500 may limit the number of reservations of a user of a second type further than the number of reservations of a user of a first type received during the predetermined time or predetermined season.

The user of the first type is a user who has a right to use the parking lot a plurality of times. That is, the user of the first type is a regular visitor such as a fixed user or a regular user. The user of the second type is a user who has a right to use the parking lot less frequently than the user of the first type. That is, the user of the second type is a spot user who has a right to use the parking lot a single time (a user who needs to apply for a use at each time of use).

When there are a plurality of designated areas in the facility, the reservation management device 500 allocates the use of designated areas associated with a first type among the plurality of designated areas for the second reservation of the user of the first type, and allocates the use of designated areas associated with a second type among the plurality of designated areas for the second reservation of the user of the second type. In this processing, the number of the designated areas allocated to the user of the first type may be larger than the number of designated areas allocated to the user of the second type. A size of the designated area allocated to the user of the first type may be larger than the size of the designated area allocated to the user of the second type. As a result, the reservation management device 500 prioritizes the second reservation of the user of the first type over the second reservation of the user of the second type.

The first reservation management information 524 and the second reservation management information 526 generated by the processing described above are provided to the parking lot management device 400. Then, the parking lot management device 400 refers to the provided first reservation management information 524 and second reservation management information 526 (the reservation management information 436) and performs the following processing.

[Entrance Processing]

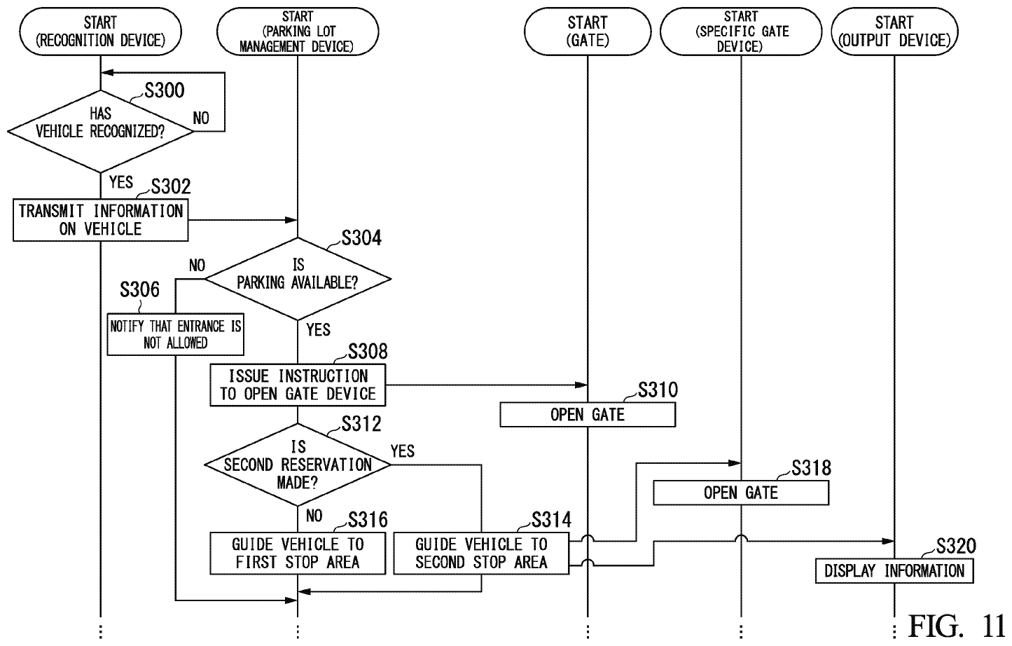

FIG. 11 is a flowchart which shows an example of a flow of entrance processing executed by the parking lot management system 1. First, it is determined whether the recognition device 900 has recognized the vehicle M (step S300). When it has recognized the vehicle M, the recognition device 900 transmits information on the vehicle M (for example, a license plate) to the parking lot management device 400 (step S302).

Next, the parking lot management device 400 refers to the information on the vehicle M transmitted in step S302, and determines whether the vehicle M that is about to enter the facility can park (step S304). When it is determined that the vehicle M cannot park, the parking lot management device 400 notifies the vehicle M that entrance is not allowed (step S306). For example, the parking lot management device 400 causes a display or a speaker provided near an entryway of the facility to output information indicating that parking is not allowed or the parking lot management device 400 notifies an address of the vehicle M (or the terminal device 600 of the user) stored in association with the license plate that entrance is not allowed. For example, the parking lot management device 400 gives a notification indicating that entrance is not allowed when there is no empty parking space in the parking lot and the vehicle M that is about to enter is the vehicle M that has not made the first reservation.

When it is determined that the vehicle M can park, the parking lot management device 400 issues an instruction to open the gate 300-in (step S308). For example, the parking lot management device 400 issues the instruction to open the gate 300-in when there is an empty parking space in the parking lot or when there is no empty parking space in the parking lot but the vehicle M that is about to enter is the vehicle M that had made the first reservation.

Next, the gate 300-in opens the gate on the basis of the instruction transmitted in step S308 (step S310). As a result, the vehicle M can enter the facility.

Next, the parking lot management device 400 determines whether the vehicle M which has entered has made the second reservation (step S312). When it is determined that the vehicle M has not made the second reservation, the parking lot management device 400 guides the vehicle M to the second stop area 310-2 (step S314). In this case, the specific gate device 800 does not permit an entry of a user or a vehicle M which are not correlated with the second reservation into the first stop area 310-1. The parking lot management device 400 guides the vehicle M toward the second stop area 310-2 by instructing the output device 700 to output information indicating that the vehicle M proceeds to the second stop area 310-2. That is, the output device 700 provides information prompting the user who is not correlated with the second reservation not to use the first stop area 310-1. As a result, the vehicle M travels toward the second stop area 310-2 and stops at the second stop area 310-2.

When it is determined that the vehicle M has made the second reservation, the parking lot management device 400 guides the vehicle M to the first stop area 310-1 for a user with a reservation (step S316). For example, the parking lot management device 400 guides the vehicle M toward the first stop area 310-1 by instructing the specific gate device 800 to open the gate. The parking lot management device 400 guides the vehicle M toward the first stop area 310-1 by instructing the output device 700 to output information indicating that the vehicle proceeds to the first stop area 310-1.

Next, the specific gate device 800 opens the gate according to an instruction of the parking lot management device 400 (step S318). That is, the specific gate device 800 permits an entry of a user or a vehicle M correlated with the second reservation. Next, the output device 700 outputs information according to an instruction of the parking lot management device 400 (step S320). The parking lot management device 400 may notify the terminal device 600 of the user of information on a stop area. The vehicle M is guided to the specific gate device 800 or the output device 700 described above, travels toward the first stop area 310-1, and stops at the first stop area 310-1.

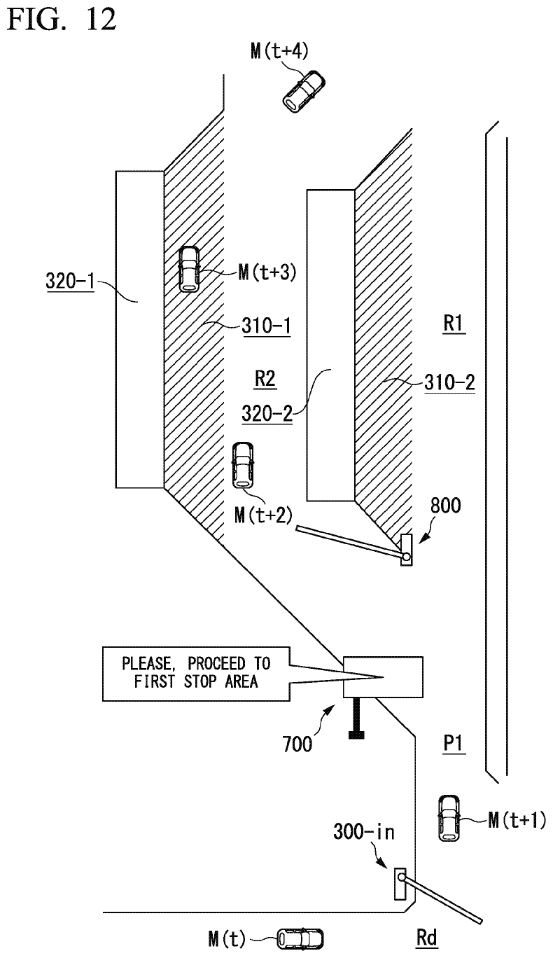

FIG. 12 is a diagram which shows an example of a state in which the vehicle M is guided to the first stop area 310-1. FIG. 12 is a diagram focusing on the main line R1, the branch road R2, the first stop area 310-1, and the second stop area 310-2 of FIG. 4. It is assumed that the vehicle M is a vehicle of a user who has made the first reservation, and the second reservation before entrance.

At the time t, the vehicle M is traveling on the road. At a time t+1, the gate of the specific gate device 800 is opened after the vehicle M has entered the facility, and information indicating that the vehicle proceeds to the first stop area 310-1 is displayed on the output device 700.

The vehicle M travels on the branch road r2 on the basis of an aspect of the specific gate device 800 or the output device 700 described above at a time t+2, and the vehicle M stops at the first stop area 310-1 at a time t+3. If the user of the vehicle M issues an entrance instruction after getting off the vehicle or unloading luggage from the vehicle in the first stop area 310-1, the vehicle M automatically travels toward the parking lot at a time t+4. Then, the vehicle M parks in a parking space of the parking lot, which associates with the first reservation.

As described above, the parking lot management device 400 refers to the reservation management information 436, and guides the vehicle M to a designated area or a non-designated area according to a reception result of the first reservation and the second reservation, thereby efficiently managing the vehicle M.

[Exit Processing]

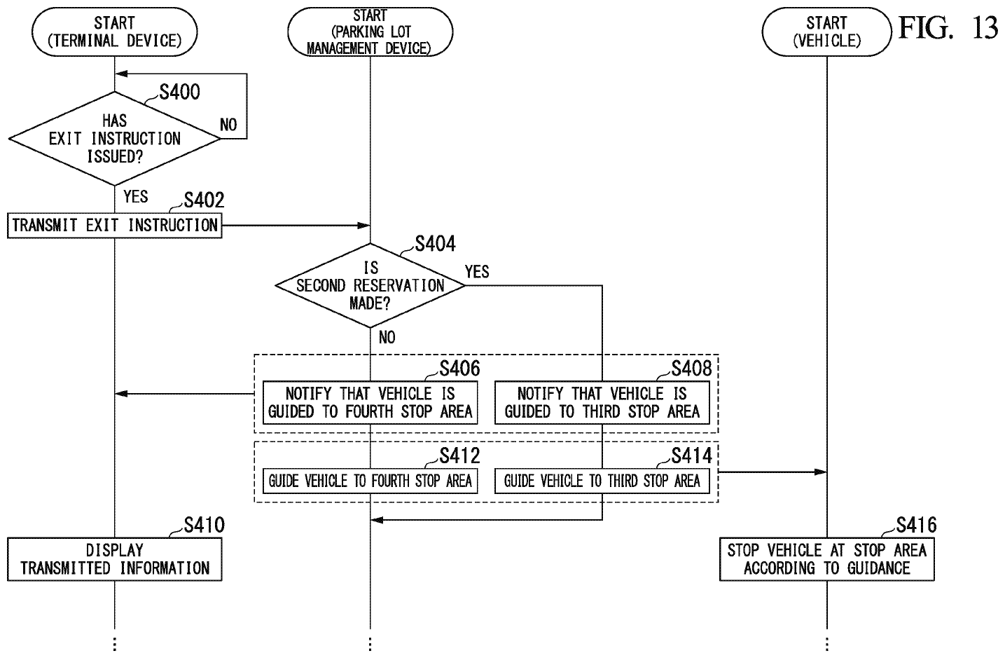

FIG. 13 is a flowchart which shows an example of a flow of exit processing executed by the parking lot management system 1. First, the terminal device 600 determines whether an exit instruction has been issued (step S400). When an exit instruction has been issued, the terminal device 600 transmits the exit instruction to the parking lot management device 400 (step S402).

Next, if the exit instruction transmitted by the terminal device 600 is acquired, the parking lot management device 400 determines whether a user who has issued the exit instruction has made the second reservation (step S404). When it has not made the second reservation, the parking lot management device 400 notifies the user that the vehicle M is guided to the fourth stop area 310-4 (step S406). When it has made the second reservation, the parking lot management device 400 notifies the user that the vehicle M is guided to the third stop area 310-3 (step S408). Notifying means that information on a guidance destination area is transmitted to the terminal device 600. The terminal device 600 causes the display to display the information transmitted in step S406 or step S408 (step S410). As a result, the user can recognize the stop area 310 or the getting-on/off area 320 at which the vehicle M stops.

After the processing of step S406, the parking lot management device 400 guides the vehicle M to the fourth stop area 310-4 (Step S412). That is, the parking lot management device 400 causes the vehicle M parking in the parking lot PA to exit from the parking lot and guides the vehicle M to the fourth stop area 310-4 when the second reservation is not received.

After the processing of step S408, the parking lot management device 400 guides the vehicle M to the third stop area 310-3 (step S414). Guiding means that the parking lot management device 400 communicates with the vehicle M and instructs the vehicle M to stop at the designated stop area.

The vehicle M travels and stops at the designated stop area according to the guidance in step S412 or step S414 (step S416). As a result, the vehicle M can stop at the designated stop area.

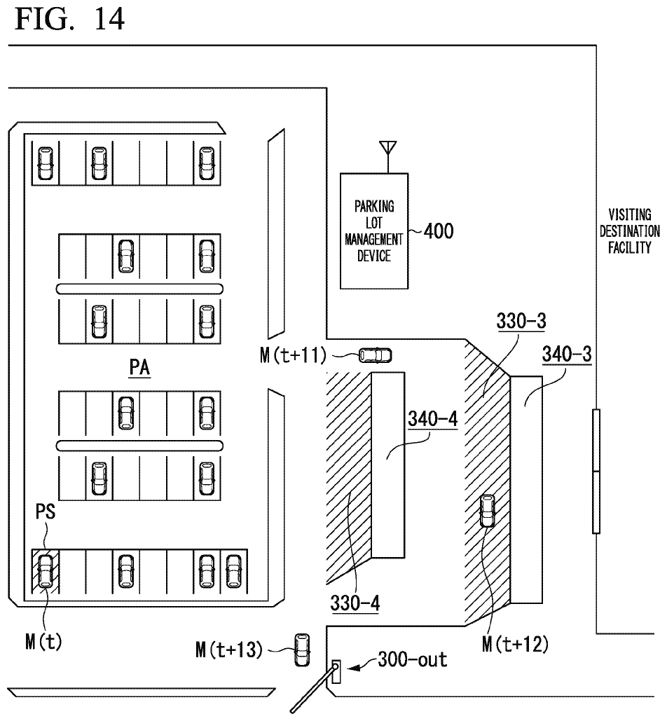

FIG. 14 is a diagram which shows an example of a state in which the vehicle M is guided to the third stop area 310-3. FIG. 14 is a diagram focusing on the parking lot PA, the third stop area 310-3, and the fourth stop area 310-4 of FIG. 4. It is assumed that the vehicle M is a vehicle of a user who has made the second reservation after an exit.

At the time t, the vehicle M has parked in the parking space PS. If the exit instruction is issued at this time, the vehicle M leaves the parking lot and is guided toward the third stop area 310-3 at a time t+11.

At a time t+12, the vehicle M stops at the third stop area 310-3 according to the guidance of the parking lot management device 400. After the user of the vehicle M getting on the vehicle or loading luggage into the vehicle in the third stop area 310-3, the vehicle M starts traveling. Then, the vehicle M passes through a gate 300-out at a time t+13.

As described above, the parking lot management device 400 refers to the reservation management information 436 and guides the vehicle M to a designated area or a non-designated area according to a reception result of the first reservation and the second reservation, thereby efficiently managing the vehicle.

According to the first embodiment described above, the parking lot management system 1 performs processing in accordance with the first reservation and the second reservation, thereby efficiently managing the vehicle M. For example, by setting the getting-on/off area as a reservation system, congestion in the getting-on/off area is alleviated or traffic congestion related to the entrance or exit of the vehicle M is alleviated. The user can get on or off the vehicle M, load luggage into the vehicle M, unload luggage from the vehicle M using the reserved time, and thus convenience for the user is improved.

### Second Embodiment

Hereinafter, a second embodiment will be described. In the second embodiment, when a user who is not correlated with the second reservation has used the first stop area 310-1 or the third stop area 310-3, the user is required to pay a higher charge than a charge paid when the user has used the second stop area 310-2 or the fourth stop area 310-4 or a higher charge than a charge paid when a user correlated to the second reservation has used the first stop area 310-1 or the third stop area 310-3. In the following description, differences from the first embodiment will be mainly described.

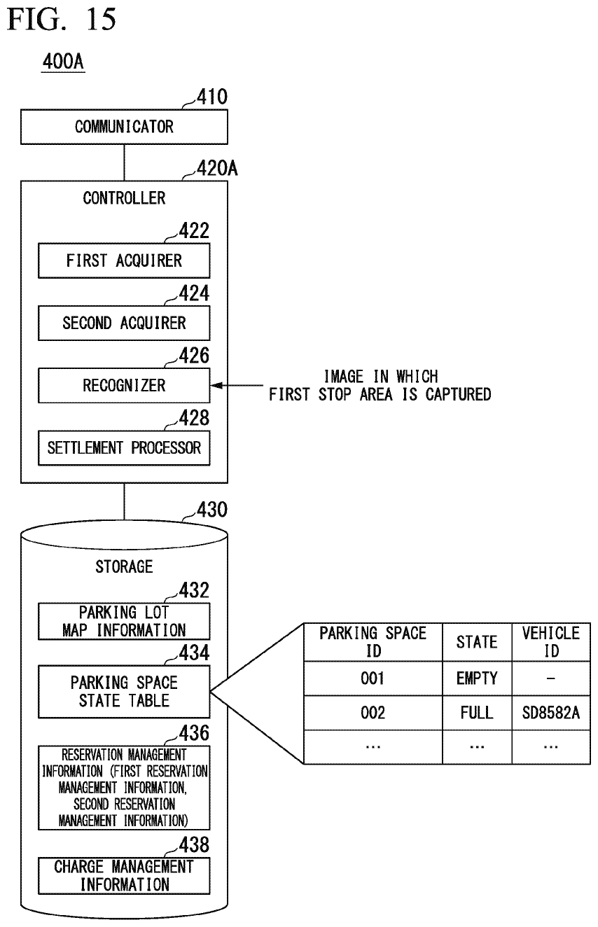

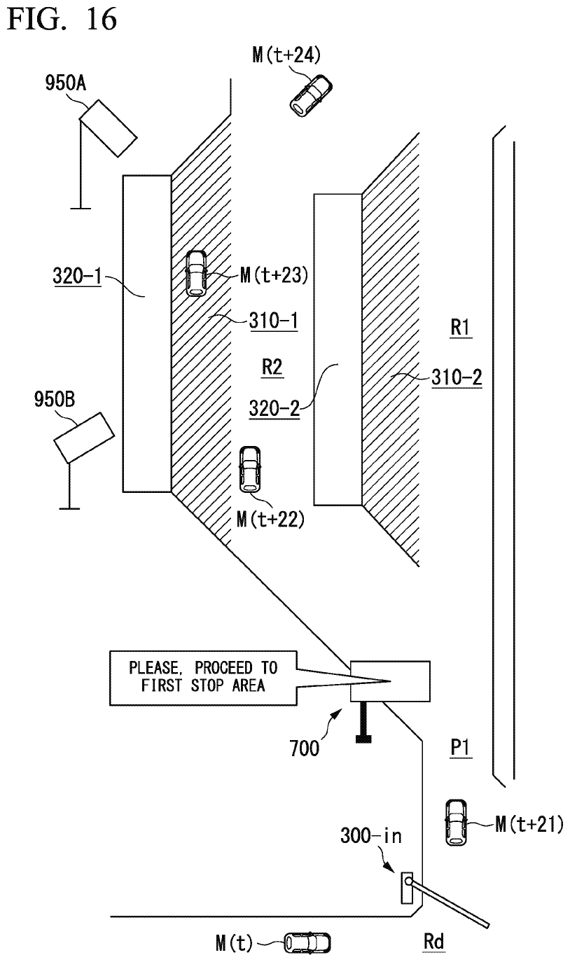

FIG. 15 is a diagram which shows an example of a functional configuration of a parking lot management device 400A of the second embodiment. The parking lot management device 400A includes a controller 420A instead of the controller 420. The controller 420A further includes, for example, a recognizer 426 and a settlement processor 428 in addition to the first acquirer 422 and the second acquirer 424. The recognizer 426 analyzes an image captured by a specific camera, and identifies a user who has used the first stop area 310-1 or the third stop area 310-3 on the basis of a result of the analysis. The specific camera is, for example, a camera that captures the first stop area 310-1 or the third stop area 310-3 (refer to FIG. 16).

The recognizer 426 acquires, for example, a license plate of the vehicle M using the first stop area 310-1 or the third stop area 310-3 from the image captured by the specific camera, and identifies a vehicle M using the stop area on the basis of the acquired license plate. Information on the license plate of the vehicle M which has made the second reservation, information on a user associated with the license plate, and the like are stored in the storage 430. The recognizer 426 determines that a user who has not made the second reservation has used the first stop area 301-1 or the third stop area 310-3 when the information on the acquired license plate is not stored in the storage 430. The recognizer 426 may identify the vehicle by communication with the vehicle M.

The settlement processor 428 calculates a use charge of the parking lot and a use charge of the stop area, and transmits a result of the calculation to a payment server (not shown). In the payment server, a payment for the use charge described above, such as a withdrawal from a bank account and a credit card payment, is performed. The settlement processor 428 performs a settlement of the use charge on the basis of time during which the vehicle M has used the stop area, time during which the parking lot is used, a status of the first reservation, and a status of the second reservation. Information used for the settlement described above is stored in the storage 430 as charge management information 438.

At this time, when the user who has not made the second reservation has used a designated area, the settlement processor 428 may derive a higher charge than a charge paid when the user has used a non-designated area, and perform a payment by associating the derived charge with the charge management information 438. When the user who has not made the second reservation has used a designated area, the settlement processor 428 may derive a higher charge than a charge paid when a user correlated with the second reservation has used the designated area, and perform a payment by associating the derived charge with the charge management information 438.

FIG. 16 is a diagram which shows an example of a scene in which a user who has not made the second reservation uses the first stop area 310-1. In the example of FIG. 16, the specific gate device 800 is not provided. At the time t, the vehicle M is traveling on a road. At a time t+21, it is assumed that information indicating the vehicle M proceeds to the second stop area 310-2 is displayed on the output device 700 after the vehicle M has entered the facility.

It is assumed that the vehicle M travels on the branch road R2 without noticing the aspect of the output device 700 described above at a time t+22, and the vehicle M stops at the first stop area 310-1 at a time t+23. The vehicle M automatically travels toward the parking lot at a time t+24 if an entrance instruction is issued after the user of the vehicle M gets off the vehicle or unloads luggage from the vehicle in the first stop area 310-1. Then, the vehicle M parks in a parking space of the parking lot, which associates with the first reservation.

At this time, a specific camera 950A (monitoring device) or a specific camera 950B (monitoring device) transmits an image in which the vehicle M is captured in the first stop area 310-1 to the parking lot management device 400. That is, the specific camera 950A and the specific camera 950B monitor a usage status of a user of a designated area. The parking lot management device 400 analyzes the transmitted image and identifies the vehicle M. Then, the parking lot management device 400 increases a charge, which is imposed to the user who has used the first stop area 310-1 without making the second reservation, higher than a reference charge. The reference charge is a charge for using the first stop area 310-1 with the second reservation.

According to the second embodiment described above, the reservation management device 500 imposes a charge higher than the reference charge when the user who has not made the second reservation has used a designated area, thereby prompting the use on the basis of rules. As a result, the parking lot management system 1 can efficiently manage the vehicle M.

[Hardware Configuration]

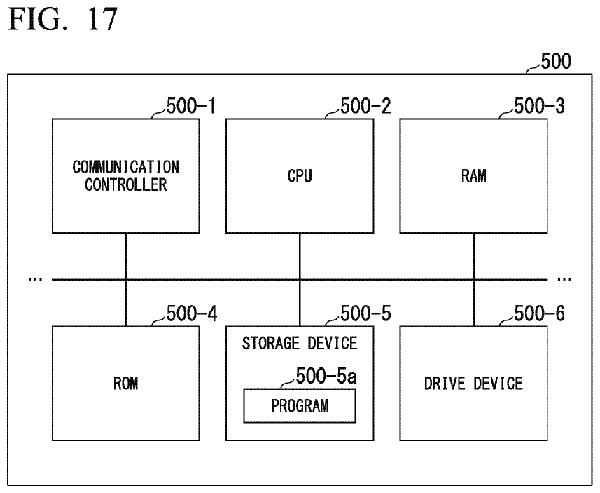

FIG. 17 is a diagram which shows an example of a hardware configuration of the reservation management device 500 of the embodiment. As shown in FIG. 17, the reservation management device 500 is configured to include a communication controller 500-1, a CPU 500-2, a random access memory (RAM) 500-3 used as a working memory, and a read only memory (ROM) 500-4 that stores a booting program and the like, a storage device 500-5 such as a flash memory or a hard disk drive (HDD), a drive device 500-6, and the like being connected to each other by an internal bus or a dedicated communication line. The communication controller 500-1 communicates with components other than the reservation management device 500. The storage device 500-5 stores a program 500-5a executed by the CPU 500-2. This program is developed in the RAM 500-3 by a direct memory access (DMA) controller (not shown) or the like, and is executed by the CPU 500-2. Accordingly, some or all of the acquirer 502, the first reservation processor 504, the second reservation processor 506, and the information processor 508 are realized. The parking lot management device 400, similarly to the above description, is configured to include a communication controller, a CPU, a RAM, a ROM, a storage device, a drive device, and the like being connected to each other by an internal bus or a dedicated communication line. Then, the program stored in the storage device is executed by the CPU, and thereby the controller 420 performs various types of processing.

The embodiments described above can be expressed as follows.

A vehicle control device includes a storage device that stores a program, and a hardware processor, in which the hardware processor executes the program stored in the storage device, thereby receiving a first reservation for a use of a parking space of a parking lot for parking a vehicle, receiving a second reservation for a use of a designated area different from the parking space of the parking lot for the first reservation, and performing processing in accordance with a result of the first reservation by a first receiver and a result of the second reservation by a second receiver.

As described above, the forms for implementing the present invention have been described using the embodiments. However, the present invention is not limited to such embodiments, and various modifications and substitutions may be added in a range not departing from the gist of the present invention.

What is claimed is:

1. A management device comprising:
a first receiver configured to receive a first reservation for a use of a parking space of a parking lot for parking a vehicle;
a second receiver configured to receive a second reservation for a use of a designated area different from the parking space of the parking lot for the first reservation; and
an information processor configured to perform processing in accordance with a result of reception by the first receiver and a result of reception by the second receiver.

2. The management device according to claim 1,
wherein the information processor is configured to execute processing for prompting a user of the vehicle to use a non-designated area different from the designated area when the first reservation is received and the second reservation is not received.

3. The management device according to claim 1,
wherein, when the first reservation and the second reservation are received, the information processor is configured to notify a terminal device of a user of the vehicle that the designated area can be used.

4. The management device according to claim 1,
wherein, when the first reservation and the second reservation are received, the information processor is configured to notify a parking lot management device that is configured to manage the use of the designated area in a facility including the parking lot of information indicating the vehicle can use the designated area such that a user of the vehicle can use the designated area.

5. The management device according to claim 1,
wherein, when the first reservation is received and the second reservation is not received, the information processor is configured to notify a terminal device of a user of the vehicle of a use of a non-designated area different from the designated area.

6. The management device according to claim 1,
wherein the designated area is an area at which the user of the vehicle boards the vehicle, an area at which the user gets off the vehicle, an area at which the user loads luggage into the vehicle, or an area at which the user takes out the luggage from the vehicle.

7. The management device according to claim 1,
wherein the first reservation includes a parking start time,
the second reservation includes a use end time, and
the information processor is configured to receive the first reservation and the second reservation when the parking start time and the use end time are included in a first predetermined time range, and does not receive the first reservation or the second reservation when the parking start time and the use end time are not included in the first predetermined time range.

8. The management device according to claim 1,
wherein the first reservation included a parking end time,
the second reservation includes a use start time, and
the information processor is configured to receive the first reservation and the second reservation when the parking end time and the use start time are included in a second predetermined time range, and does not is configured to receive the first reservation or the second reservation when the parking end time and the use start time are not included in the second predetermined time range.

9. The management device according to claim 1,
wherein the second reservation includes a use time for using the designated area, and
the information processor is configured to receive the second reservation including a use time designated in unit time.

10. The management device according to claim 1,
wherein the information processor is configured to prioritize the second reservation of a user of a first type over the second reservation of a user of a second type.

11. The management device according to claim 1,
wherein a plurality of the designated areas are present, and
the information processor is configured to allocate the use of the designated area associated with a first type among the plurality of the designated areas for the second reservation of a user of a first type, and is configured to allocate the use of the designated area associated with a second type among the plurality of the designated areas for the second reservation of a user of a second type.

12. The management device according to claim 10,
wherein the user of the first type is a user who has a right to use the parking lot a plurality of times, and
the user of the second type is a user who has a right to use the parking lot less frequently than the user of the first type.

13. A management system comprising:
the management device according to claim 1; and
a guidance device configured to cause a vehicle parking in the parking lot to exit from the parking lot and guide the vehicle to the designated area when the second reservation is received.

14. The management system according to claim 13,
wherein the guidance device is configured to cause a vehicle parking in the parking lot to exit from the parking lot and is configured to guide the vehicle to a non-designated area different from the designated area when the second reservation is not received.

15. A management system comprising:
the management device according to claim 1; and
a guidance device configured to guide a vehicle that has entered a facility having the parking lot to the designated area when the second reservation is received.

16. The management system according to claim 15,
wherein the guidance device is configured to guide the vehicle that has entered the facility having the parking lot to a non-designated area different from the designated area when the second reservation is not received.

17. A management system comprising:
the management device according to claim 1; and
a gate device configured to permit or not to permit an entrance into the designated area,
wherein the gate device permits an entry of a user or a vehicle correlated with the second reservation, and does not permit an entry of a user or a vehicle which is not correlated with the second reservation.

18. A management device comprising:
a first acquirer configured to acquire a first reservation for a use of a parking space of a parking lot for parking a vehicle;
a second acquirer configured to acquire a second reservation for a use of a designated area different from the parking space of the parking lot for the first reservation; and
a guidance controller configured to guide a vehicle to a non-designated area different from the designated area when the first acquirer has not acquired a first reservation and the second acquirer has acquired a second reservation.

19. The management device according to claim 18,
wherein the guidance controller is configured to guide the vehicle to the designated area when the first acquirer has acquired a first reservation and the second acquirer has acquired a second reservation.

20. A management method comprising:
by a computer,
receiving a first reservation for a use of a parking space of a parking lot for parking a vehicle;
receiving a second reservation for a use of a designated area different from the parking space of the parking lot for the first reservation; and
performing processing in accordance with a reception result of the first reservation and a reception result of the second reservation.

21. A non-transitory computer-readable storage medium that stores a computer program to be executed by a computer to perform at least:
receive a first reservation for a use of a parking space of a parking lot for parking a vehicle;
receive a second reservation for a use of a designated area different from the parking space of the parking lot for the first reservation; and
perform processing in accordance with a reception result of the first reservation and a reception result of the second reservation.
